(19) United States
(12) Patent Application Publication
(10) Pub. No.: US 2015/0074695 A1
(43) Pub. Date: Mar. 12, 2015

(54) METHOD FOR CHANNEL SELECTION, CHANNEL SELECTING DEVICE, AND TELEVISION SYSTEM INCLUDING THE CHANNEL SELECTING DEVICE AND A TELEVISION DEVICE

(71) Applicant: Top Victory Investments Limited, Hong Kong (CN)

(72) Inventors: Chang-Hsien Chuang, New Taipei City (TW); Shao-Ching Lu, New Taipei City (TW); Che-Hsuan Liu, New Taipei City (TW)

(73) Assignee: TOP VICTORY INVESTMENTS LIMITED, Hong Kong (CN)

(21) Appl. No.: 14/025,494

(22) Filed: Sep. 12, 2013

(51) Int. Cl. H04N 21/4415; H04N 21/466; H04N 21/442; H04N 21/482

(52) U.S. Cl. CPC H04N 21/4415; H04N 21/482; H04N 21/466; H04N 21/44222
USPC 725/11; 725/56

(57) ABSTRACT

In a method for selecting one of a plurality of channels, a channel selecting device that is coupled to a television device stores at least a channel statistical data of total watching time of each of the channels. In the method, immediately after the television device is turned on, the channel selecting device selects a preferred channel from the plurality of channels, which has been watched most frequently, according to the channel statistical data.

### BACKGROUND OF THE INVENTION

1. Field of the Invention

The invention relates to a method for controlling a television device, more particularly to a method for controlling the television device to automatically select a preferred channel of a user.

2. Description of the Related Art

Conventionally, when a television device, such as an analog television or a digital television, is turned on, a specific channel will be displayed. For example, some conventional television devices are configured to display signals from a default channel. Alternatively, some conventional television devices are configured to display signals from a last-viewed channel that was being displayed just before the time the television devices were last turned off.

In such cases, upon turning on the conventional television device, a user typically does not get a preferred program of his/hers immediately displayed for a number of reasons. For example, between two viewing sessions of one particular user, the conventional television device may be operated by other people with different viewing preferences. Therefore, when the particular user turns on the conventional television device again, the last-viewed channel (by others) is displayed, which may not be broadcasting the program preferred by the user. Alternatively, the user may have different preferred programs being aired at different time slots and/or days and at various channels. For instance, a football game is typically held at 8:30 P.M., ET at a sports channel every Monday, while a blockbuster movie premiere may be aired at Saturday nights at movie channels. Therefore, with the conventional television device and the given viewing preferences, a user who prefers to watch both the football game and/or the movie premiere may not have the respective programs immediately displayed when he/she turns on the conventional television device at respective times, and therefore may have to operate the conventional television device to surf through the plurality of channels to locate his/her preferred program.

### SUMMARY OF THE INVENTION

Therefore, one object of the present invention is to provide a method for selecting one of a plurality of channels, said one of the channels being a preferred one to a specific user. The method enables immediate display of the selected channel for viewing by the user.

Accordingly, a method of the present invention is for selecting one of a plurality of channels. The method is to be implemented by a channel selecting device that is coupled to a television device and that stores at least a channel statistical data of total watching time of each of the channels. In the method, immediately after the television device is turned on, the channel selecting device selects a preferable channel from the plurality of channels, which has been watched most frequently, according to the channel statistical data.

Another object of the present invention is to provide a channel selecting device that is configured to execute the aforementioned method.

Accordingly, a channel selecting device of the present invention is configured to be coupled to a television (TV) device for selecting one of plural channels. The channel selecting device includes a TV signal receiver, a memory unit, and a processor.

The TV signal receiver is for receiving a plurality of TV signals respectively from the plurality of channels. The memory unit stores at least a channel statistical data of total watching time of each of the channels. The processor is coupled to the TV signal receiver and the memory unit, and is operable to select a preferred channel. The preferred channel is one that has been watched most frequently, and is selected according to the channel statistical data immediately after the television device is turned on.

Yet another object of the present invention is to provide a television system that includes the aforementioned channel selecting device.

Accordingly, a television system of the present invention includes a television device and a channel selecting device.

The channel selecting device is coupled to the television device for selecting one of a plurality of channels, and includes a TV signal receiver, a memory unit and a processor.

The TV signal receiver is for receiving a plurality of TV signals respectively from the plurality of channels. The memory unit stores at least a channel statistical data of total watching time of each of the channels. The processor is coupled to the TV signal receiver and the memory unit, and is operable to select a preferred channel. The preferred channel is one that has been watched most frequently, and is selected according to the channel statistical data immediately after the television device is turned on.

### BRIEF DESCRIPTION OF THE DRAWINGS

Other features and advantages of the present invention will become apparent in the following detailed description of the preferred embodiments with reference to the accompanying drawings, of which:

FIG. 1 is a schematic functional block diagram of a first preferred embodiment of a television system according to the invention;

FIG. 2 is a schematic functional block diagram illustrating a variation of the television system of the first preferred embodiment;

FIG. 3 is a flow chart illustrating steps of a method for channel selection, according to the preferred embodiment; and

FIG. 4 is a schematic functional block diagram of a second preferred embodiment of a television system according to the invention.

### DETAILED DESCRIPTION OF THE PREFERRED EMBODIMENTS

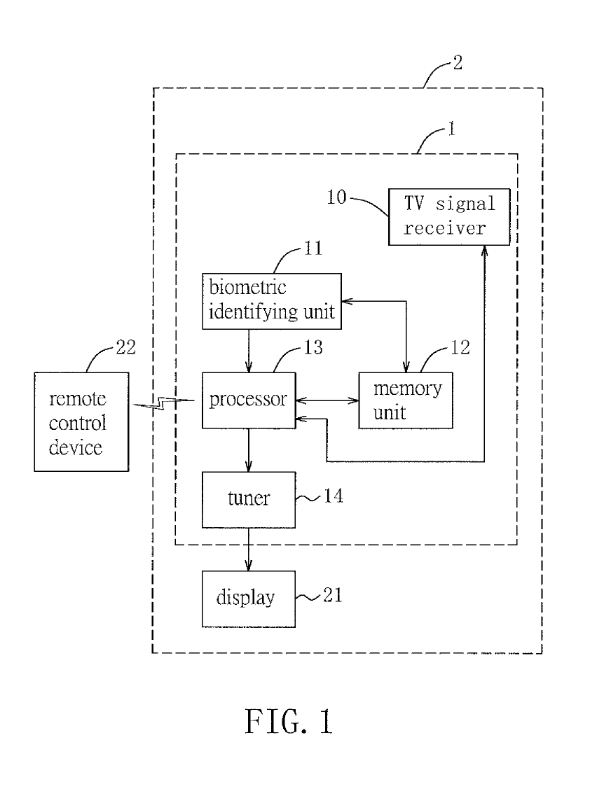

As shown in FIG. 1, the first preferred embodiment of a television system according to the present invention comprises a channel selecting device 1 and a television (TV) device 2. The television system can be controlled using a remote control device 22.

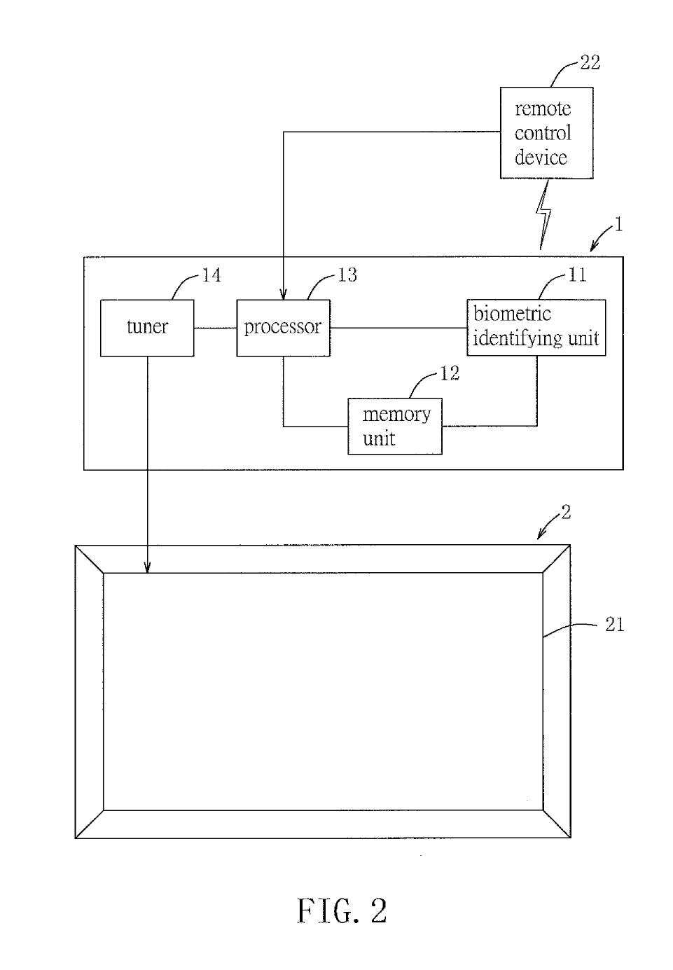

The TV device 2 includes a display 21. In this embodiment, the channel selecting device 1 is built in the television device 2. However, in a variation as shown in FIG. 2, the channel selecting device 1 may be embodied as a set-top box which is an external component coupled to the television device 2.

The channel selecting device 1 includes a TV signal receiver 10, a biometric identifying unit 11, a memory unit 12, a processor 13 and a tuner 14

The TV signal receiver 10 is capable of receiving a plurality of respective TV signals (encoded with audio and video signals that constitute a television program) of a plurality of TV channels. The biometric identifying unit 11 is configured to obtain a biometric feature of a current user who turns on the television device 2. Specifically, in this embodiment, the biometric identifying unit 11 may include one or more cameras (not shown in the drawings) that are capable of capturing a facial image of the current user as the biometric feature.

The memory unit 12 is pre-stored with a plurality of personal profiles, each being dedicated to one of a plurality of existing users. To be specific, each of the personal profiles includes channel statistical data of total watching time of each of the TV channels, and biometric data of the one of the existing users.

The following Table 1 illustrates an example of three personal profiles dedicated to existing users A, B and C, respectively.

TABLE 1

| | | |
|---|---|---|
| User A | Biometric data of user A | Channel statistical data |
| | | of user A |
| User B | Biometric data of user B | Channel statistical data |
| | | of user B |
| User C | Biometric data of user C | Channel statistical data |
| | | of user C |

In this embodiment, the channel statistical data includes total watching time of each of the TV channels watched by the particular user (i.e., User A, B or C) during each of a plurality of time periods in a day. For example, an NBA basketball game is typically played from 7:05 to 10:00 PM, ET, and is usually popular among some users (e.g., User A). A sketch comedy show may be broadcasted from 9:00 to 11:00 PM, ET, and may be favored by other users (e.g., Users B and C).

The processor 13 is coupled to the TV signal receiver 10, the biometric identifying unit 11, the memory unit 12, and the tuner 14. The processor 13 may also be configured to communicate with the remote control device 22.

The tuner 14 is coupled to the display 21, and is controlled by the processor 13 to provide the TV signal of one of the TV channels to the display 21 for playing a program of said one of the TV channels.

It is noted that, when the television device 2 is turned on, the biometric identifying unit 11 obtains the biometric feature of the current user, and, when the current user (e.g., a new user D) is identified as being not one of the existing users, the processor 13 is operative to create a new personal profile dedicated to the current user, to record a total watching time of each of the TV channels watched by the current user, and to store, into the memory unit 12, a total watching time as the channel statistical data dedicated to the current user and the biometric feature as the biometric data of the current user. The following Table 2 illustrates the resulting content of the personal profiles stored in the memory unit 12.

TABLE 2

| | | |
|---|---|---|
| User A | Biometric data of user A | Channel statistical data |
| | | of user A |
| User B | Biometric data of user B | Channel statistical data |
| | | of user B |
| User C | Biometric data of user C | Channel statistical data |
| | | of user C |
| User D | Biometric data of user D | Channel statistical data |
| | | of user D |

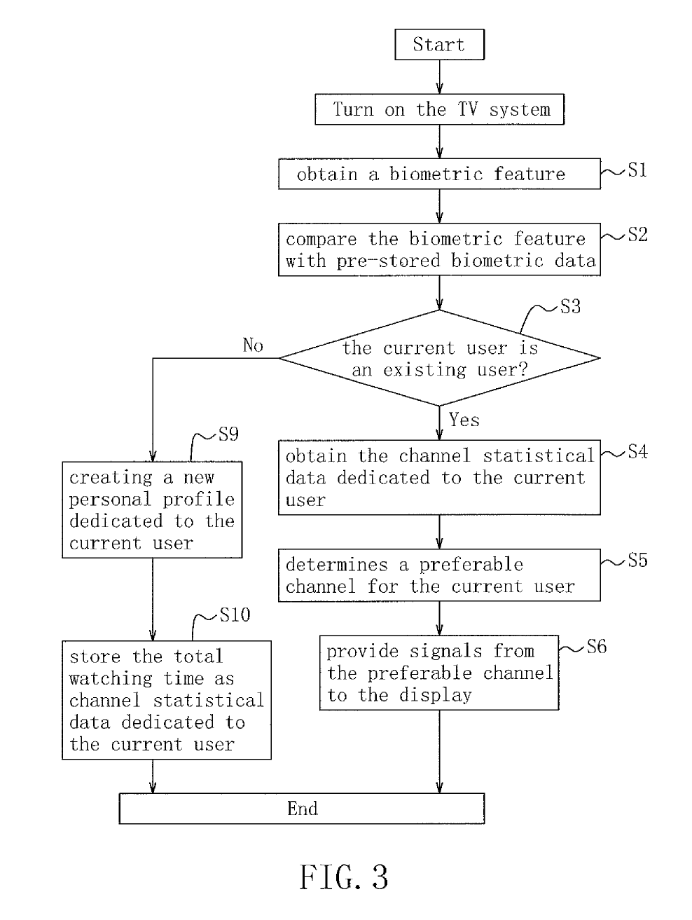

FIG. 3 shows steps of a method that is executed by the channel selecting device 1 to select a preferred channel.

Firstly, a current user turns on the TV device 2. In step S1, the biometric identifying unit 11 obtains a biometric feature of the current user, such as a facial image. Then, in step S2, the biometric identifying unit 11 compares the biometric feature of the current user obtained thereby with the biometric data of the existing users (Users A, B and C) stored in the memory unit 12.

In step S3, when the biometric feature obtained thereby conforms with the biometric data contained in one of the personal profiles, the biometric identifying unit 11 identifies the current user as an existing user (e.g., user A), and the flow proceeds to step S4. Otherwise, in a case that a new User D turns on the TV device 2, the flow proceeds to steps S9 and S10.

In step S4, the biometric identifying unit 11 notifies the processor 13 that the current user is User A, and the processor 13 looks up the personal profiles stored in the memory unit 12 to obtain the channel statistical data dedicated to User A. Subsequently, in step S5, the processor 13 determines a preferred channel for User A, based on the channel statistical data. For example, when the television system is turned on at 8:00 PM, ET by User A, the processor 13 may determine the channel that is broadcasting the NBA game as the preferred channel for User A. Alternatively, when the television system is turned on at 9:30 PM, ET by User B, the processor 13 may determine the channel that is broadcasting the sketch comedy show as the preferred channel for User B.

Afterward, in step S6, the processor 13 selects the preferred channel, and controls the tuner 14 to provide the TV signals of the preferred channel to the display 21, such that the display 21 is able to display the preferred channel.

In the case that the biometric identifying unit 11 determines the current user as a new user in step S3, the biometric identifying unit 11 notifies the processor 13 that the current user is a new user (e.g., User D) and the processor 13 creates a new personal profile for User D in step S9. Then, in step S10, the processor 13 records a total watching time of each of the TV channels watched by User D, and stores the total watching time as the channel statistical data dedicated to User D and the biometric feature obtained by the biometric identifying unit 11 as the biometric data of User D.

In brief, the method described above enables the TV device 2 to display the preferred program from the preferred channel to the current user immediately after the TV device 2 is turned on.

In some embodiments, the TV signal receiver 10 is provided with capabilities to communicate with a website (such as ones with streaming services, e.g., YouTube) via the Internet, and is able to receive at least one web channel provided by the website. Accordingly, the preferred channel may be selected from the channels including the TV channels and the web channel provided by the website.

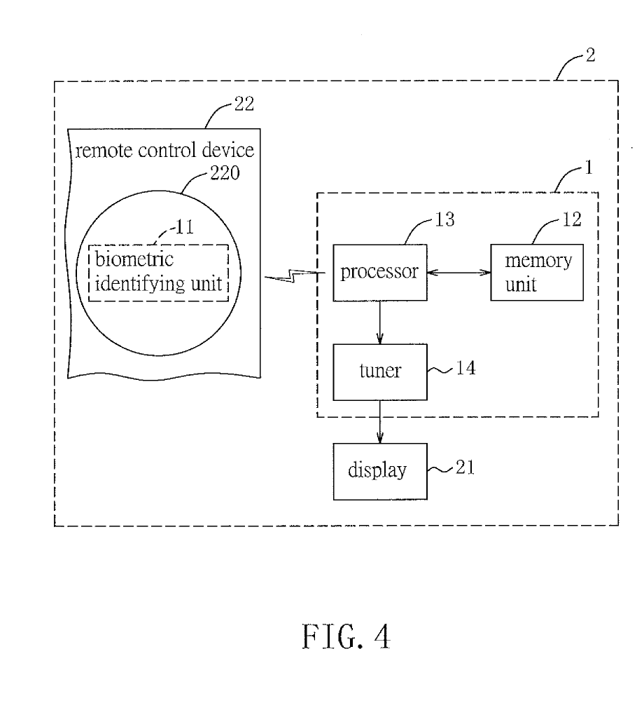

As shown in FIG. 4, the second preferred embodiment of the television system according to the present invention has a structure similar to that of the first embodiment. The main difference between this embodiment and the previous embodiment resides in the configuration of the biometric identifying unit 11, which is coupled to the remote control device 22. For example, the remote control device 22 may include a power-on button 220 that is provided with backlight and a fingerprint scanner as the biometric identifying unit 11 disposed under the power button 220. When the current user presses the power button 220, the biometric identifying unit 11 is capable of obtaining a fingerprint of the current user as the biometric feature. Since other processes performed by the television system is similar to those described in the previous embodiment, details thereof are omitted herein for the sake of brevity.

It is noted that, in a case where the biometric identifying unit 11 is not present or is disabled, regardless of the individual user, the processor 13 is configured to record a total watching time of each of the channels watched by all users during each of a plurality of time periods in a day. That is, the processor 13 operates as if there is only one user who uses the television system in every occasion.

To sum up, the present invention provides a novel approach to record channel statistical data dedicated to a particular user, and to identify the user using a biometric feature upon turning on the TV device 2, such that the user may be presented with his/her preferred program immediately without having to surf through the channels beforehand.

While the present invention has been described in connection with what are considered the most practical and preferred embodiments, it is understood that this invention is not limited to the disclosed embodiments but is intended to cover various arrangements included within the spirit and scope of the broadest interpretation so as to encompass all such modifications and equivalent arrangements.

What is claimed is:

1. A method for selecting one of a plurality of channels to be displayed on a television (TV) device, said method to be implemented by a channel selecting device that is coupled to the television device and that stores at least a channel statistical data of total watching time of each of the channels, said method comprising the step of:
a) selecting, by the channel selecting device, a preferred channel, which has been watched most frequently, according to the channel statistical data immediately after the television device is turned on.

2. The method as claimed in claim 1, the channel statistical data being dedicated to a particular user, the channel selecting device further storing at least a biometric data dedicated to the particular user, wherein said method further comprises, before step a), the following steps of:
i) when a current user turns on the television device, obtaining, by the channel selecting device, a biometric feature of the current user;
ii) comparing, by the channel selecting device, the biometric feature of the current user obtained in step i) with the biometric data of the particular user stored in the channel selecting device;
iii) identifying, by the channel selecting device, the current user as the particular user when the biometric feature obtained in step i) conforms with the biometric data stored in the channel selecting device; and
iv) executing, by the channel selecting device, step a) to select the preferred channel according to the channel statistical data dedicated to the particular user.

3. The method as claimed in claim 2, further comprising, after step ii), the following steps of:
storing, by the channel selecting device, the biometric feature of the current user when the biometric feature obtained in step i) does not conform with the biometric data stored in the channel selecting device;
recording, by the channel selecting device, a total watching time of each of the channels watched by the current user; and
storing, by the channel selecting device, the total watching time as the channel statistical data dedicated to the current user and the biometric feature obtained in step i) as the biometric data dedicated to the current user.

4. The method as claimed in claim 2, wherein, in step i), the channel selecting device is operable to obtain one of a fingerprint and a facial image as the biometric feature.

5. The method as claimed in claim 1, further comprising, before step a), the following steps of:
recording, by the channel selecting device, a total watching time of each of the channels watched during each of a plurality of time periods in a day; and
storing, by the channel selecting device, the total watching time as the channel statistical data;
wherein, in step a), the channel selecting device selects a preferred channel, which has been watched most frequently during one of the time periods in a day when the television device is turned on.

6. The method as claimed in claim 1, the channel statistical data being dedicated to a particular user and including a total watching time of each of the channels watched by the particular user during each of a plurality of time periods in a day,
wherein, in step a), the channel selecting device selects a preferred channel, which has been watched most frequently during one of the time periods in a day when the television device is turned on.

7. The method as claimed in claim 1, the channel selecting device being able to communicate with a website via the Internet,
wherein, in step a), the preferred channel is selected from the channels including television channels and at least one web channel provided by the website.

8. A channel selecting device configured to be coupled to a television (TV) device for controlling the TV device to select one of plural channels, said channel selecting device comprising:
a TV signal receiver for receiving a plurality of respective TV signals of the channels;
a memory unit storing at least a channel statistical data of total watching time of each of the channels; and
a processor coupled to said TV signal receiver and said memory unit, and configured to be coupled to the TV device for selecting a preferred channel, which has been watched most frequently and which is to be displayed by the TV device, according to the channel statistical data immediately after the television device is turned on.

9. The channel selecting device as claimed in claim 8, further comprising a biometric identifying unit coupled to said processor and operable to obtain a biometric feature of a user,
wherein the channel statistical data stored in said memory unit is dedicated to a particular user, and said memory unit further stores at least a biometric data dedicated to the particular user,
wherein, when a current user turns on the television device,
said biometric identifying unit is operative to obtain a biometric feature of the current user, to compare the biometric feature of the current user obtained thereby with the biometric data of the particular user stored in said memory unit, and to identify the current user as the particular user when the biometric feature obtained thereby conforms with the biometric data stored in said memory unit, and
said processor is operative, according to the identification result from said biometric identifying unit, to control the TV device to select the preferred channel according to the channel statistical data dedicated to the particular user.

10. The channel selecting device as claimed in claim 9, wherein said processor is further operative to:
store the biometric feature of the current user into said memory unit when the biometric feature obtained by said biometric identifying unit does not conform with the biometric data stored in said memory unit;
record a total watching time of each of the channels watched by the current user; and
store, into said memory unit, the total watching time as the channel statistical data dedicated to the current user and the biometric feature as the biometric data dedicated to the current user.

11. The channel selecting device as claimed in claim 9, wherein said biometric identifying unit is operative to obtain one of a fingerprint and a facial image as the biometric feature.

12. The channel selecting device as claimed in claim 8, wherein said processor is further operative to:
record a total watching time of each of the channels watched during each of a plurality of time periods in a day;
store the total watching time as the channel statistical data into said memory unit; and
select the preferred channel as one of the channels that has been watched most frequently during one of the time periods in a day when the television device is turned on.

13. The channel selecting device as claimed in claim 8, wherein the channel statistical data stored in said memory unit is dedicated to a particular user and includes a total watching time of each of the channels watched by the particular user during each of a plurality of time periods in a day, and
wherein said processor is further operative to select the preferred channel as one of the channels that has been watched most frequently during one of the time periods in a day when the television device is turned on.

14. The channel selecting device as claimed in claim 8, wherein said channel selecting device is able to communicate with a website via the Internet, and said processor is operative to select the preferred channel from the channels including a plurality of television channels and at least one web channel provided by the website.

15. A television system comprising:
a television (TV) device; and
a channel selecting device that is coupled to said TV device for selecting one of a plurality of channels, said channel selecting device including
a TV signal receiver for receiving a plurality of respective TV signals of the channels,
a memory unit storing at least a channel statistical data of total watching time of each of the channels, and
a processor coupled to said TV signal receiver, said memory unit and said TV device, and operable to select a preferred channel, which has been watched most frequently and which is to be displayed by said TV device, according to the channel statistical data immediately after said TV device is turned on.

16. The television system as claimed in claim 15, wherein said channel selecting device further includes a biometric identifying unit coupled to said processor and operable to obtain a biometric feature of a user,
wherein the channel statistical data stored in said memory unit is dedicated to a particular user, and said memory unit further stores at least a biometric data dedicated to the particular user,
wherein, when a current user turns on the television device,
said biometric identifying unit is operative to obtain a biometric feature of the current user, to compare the biometric feature of the current user obtained thereby with the biometric data of the particular user stored in said memory unit, to identify the current user as the particular user when the biometric feature obtained thereby conforms with the biometric data stored in said memory unit, and
said processor is operative, according to the identification result from said biometric identifying unit, to select the preferred channel according to the channel statistical data dedicated to the particular user.

17. The television system as claimed in claim 16, wherein said processor is further operative to:
store the biometric feature of the current user into said memory unit when the biometric feature obtained by said biometric identifying unit does not conform with the biometric data stored in said memory unit;
record a total watching time of each of the channels watched by the current user; and
store, into said memory unit, the total watching time as the channel statistical data dedicated to the current user and the biometric feature as the biometric data dedicated to the Current user.

18. The television system as claimed in claim 15, wherein said biometric identifying unit includes at least one of a fingerprint scanner for obtaining a fingerprint as the biometric feature and a camera for capturing a facial image as the biometric feature.

19. The television system as claimed in claim 18, further comprising a remote control device capable of communicating with said channel selecting device and provided with said biometric identifying unit.
